(19) United States
(12) Patent Application Publication
(10) Pub. No.: US 2010/0307143 A1
(43) Pub. Date: Dec. 9, 2010

(54) IC power plant, and method of operation

(76) Inventor: Anthony Colette, Canyon Country, CA (US)

Correspondence Address: Terry L. Miller, 24832 Via San Fernando, Mission Viejo, CA, 92692, US

(21) Appl. No.: 12/455,704

(22) Filed: Jun. 5, 2009

(51) Int. Cl. F01N 3/10; F02B 27/02; F01N 7/00

(52) U.S. Cl. 60/299; 60/312; 60/324

(57) ABSTRACT

An internal combustion (IC) power plant includes an IC engine and exhaust system in combination. The IC engine of the power plant produces considerably greater torque and horse power, reduced emissions, improved volumetric efficiency, compared to an identical IC engine not combined with the inventive exhaust system.

### BACKGROUND OF THE INVENTION

1. Field of the Invention

The present invention relates generally to an improved internal combustion (IC) power plant (i.e., spark ignition, and generally fueled by gasoline or another fuel) or Diesel (i.e., compression ignition) 4-stroke cycle variety. 4-Stroke engines, which are generally but not necessarily piston engines, inherently have a pulsatile intake and exhaust flow, into and from the combustion chamber(s). The inventive IC power plant has an enhanced or improved pulsatile exhaust, gas flow so that one or more advantages, such as: improved volumetric efficiency, improved fuel economy, improved torque and horsepower production (especially at low engine speeds), reduced catalytic converter size (i.e., for gasoline-fueled automotive engines), as well as other benefits are realized.

The improved IC power plant according to this invention may find application to, for example, stationary or portable electrical power generation; propulsion of aircraft, boats, or automobiles; operation of heavy trucks and construction equipment; water pumping; and a variety of other uses in which a 4-stroke cycle internal combustion engine is or can be used. More Particularly, this invention relates to such an improved IC power plant in which the exhaust system includes one or more echo chambers (i.e., reactive or resonant chambers) in exhaust gas flow communication with the IC engine as close as is practicable to the exhaust valves of the engine, so as to provide echoing of exhaust pulsatile flow at the exhaust valve(s) and combustion chamber(s) of the engine. An improved volumetric efficiency for the IC engine (especially at low engine speeds) as well as other benefits result. For example, injection of sound energy from the echo chamber(s) into the combustion chambers of the engine via the exhaust valves is believed to assist in vaporizing fuel droplets, and possibly to act as a form of turbulence in the combustion chambers, thus improving flame propagation and combustion efficiency of the engine. Another one of the additional benefits of this present invention is a reduction in peak exhaust gas flow velocity in the exhaust system at selected locations downstream of the exhaust valves of the engine, and a resultant increase in residence time for exhaust gasses in a catalytic converter (i.e., for a gasoline-fueled automotive engine, if so equipped) of the exhaust system. Increased residence time for exhaust gasses in a catalytic converter allows the use of a smaller converter with concomitant decrease in the use of precious metals (i.e., platinum, for example).

The echo chamber(s) according to the present invention may also be constructed with a variable geometry, or may include a valving device, so as to provide a variable-volume or variable-length of echo chamber(s) communicating with the exhaust ports and valves of an IC engine, and consequently being in exhaust gas flow communication with the combustion chambers of the IC engine. The Applicant believes that by selection of the proper volume, length, and location of the echo chamber(s) according to this invention relative to the exhaust valves of an IC engine that enhanced pulsatile flow in the exhaust system will assist in both exhaust scavenging, and reduced loss of fresh charge from the combustion chambers of the engine. Also, as mentioned above, echo injection into the combustion chamber(s) of the engine via the exhaust ports is believed to possibly assist in fuel atomization and the generation of turbulence in the combustion chamber(s) leading to improved combustion conditions, including improved flame propagation. An improved power output for the engine, particularly improved torque and horse power production results. Actual testing of an otherwise stock (i.e., as originally manufactured) automobile on a chassis dynamometer with an exhaust system according to this invention has shown a remarkable increase in torque and horsepower production of a gasoline-fueled IC power plant according to this invention. One result might be that automotive passenger vehicles (i.e., automobiles), for example, can be satisfactorily powered by smaller IC engines using less fuel and producing less air pollution. The inventive exhaust system may also include conventional exhaust piping leading to an exhaust outlet or discharge, and also possibly including one or more conventional mufflers effective to reduce exhaust noises of the IC power plant.

2. Related Technology

IC engines generally and historically have used one or more mufflers in order to both reduce the noise level of the engine exhaust and possibly to enhance pleasant frequencies or tones in the exhaust. The conventional mufflers and exhaust systems are also configured to control undesired resonance(s) or droning in the exhaust system, and to provide a desired level of quietness, or in some cases to provide a somewhat more noisy “performance” sound for an automobile for example. In the automotive context, exhaust systems are generally graded or ranked in comparison to the performance loss that they cause in comparison to an “open pipes” exhaust system, and in terms of the level of exhaust noise they inflict on passengers and on bystanders of the vehicle.

So called high performance headers for automotive vehicles have been known for some time, which are an exhaust system including primary tubes all of a selected length, each leading to a collector where the tubes are joined, and leading hence to an exhaust pipe which may simply be open, or may possibly include one or more mufflers. The selected length of the primary tubes of the exhaust header are selected in view of the intended use of the vehicle and appear to improve or enhance torque or horse power production within particular speed ranges. However, such header tuning is believed to provide only relatively weak pressure pulsations at the exhaust ports and valves of an IC engine. Further, such headers are not believed to result in injection of echoes or sound energy into the combustion chamber(s) of the IC engine on which they are used. Thus, it would appear that combustion conditions within the combustion chambers of an IC engine equipped with conventional high performance exhaust header are not improved with respect to fuel atomization, combustion turbulence generation, or with respect to propagation of the combustion flame front. Also, it is believed that conventional headers do not improve the volumetric efficiency of an engine to the degree possible with the present invention. Conventional “tuned” headers of the type discussed here do not (and are believed not possible of) providing the very remarkable increase in torque and horse power from an IC power plant which are evidenced by the present invention.

Similarly, exhaust systems for IC engines (i.e., in passenger automobiles) have been know for some time which include resonant or reactive chambers intended to reduce resonance or droning of the exhaust system at particular engine speeds, or within particular engine speed ranges, so that passengers of the vehicle are not subjected to an undesirable noise, vibration, or harshness (i.e., “NVH” in common engineering terminology). Again, these conventional resonant chambers are generally rather small structures simply and only for NVH control, and are not known to provide any injection of echoes or sound energy into the combustion chambers of the IC engine on which they are used. Indeed, such resonant chambers for NVH purposes are generally part of the exhaust system on passenger cars of moderate or low performance, in which horsepower and torque production of the IC engine have been greatly compromised in the interest of comfort and civility of the vehicle. No improvement in engine performance (i.e., torque or horse power output) or fuel economy is known to result from such resonant chamber used to control NVH. Again, such conventional exhaust systems do not display the startling improvements in torque and horse power which are provided by the present invention.

### SUMMARY OF THE INVENTION

In view of the deficiencies of the conventional related technology, it is an object of this invention to overcome or reduce one or more of these deficiencies.

Another objective for this invention is to improve the torque and horse power production of a gasoline-fueled automobile engine;

Still another objective for this invention is to allow the use of smaller catalytic converters on gasoline-fueled automobile engines;

An object for this invention is also to improve gasoline fuel efficiency for an automobile engine;

These and other objectives and resultant additional advantages may be realized by the present invention according to this disclosure.

Corporate Average Fuel Economy (CAFE)

An important consideration for the present invention is improvement of Corporate Average Fuel Economy (CAFE) figures, especially for automobiles and light trucks. CAFE requirements have historically been difficult for manufacturers to meet, and their failures to meet CAFE requirements has resulted in many automobile manufactures having to pay fines and other charges to various governments around the world. A major consideration in the efforts to meet CAFE requirements is the expectations and demands of consumers for a certain level of performance and drivability of new cars, versus the small size of conventional IC engines that would be necessary in order to successfully meet CAFE requirements. This present invention may well allow a much smaller engine to satisfy consumer's performance and drivability expectations, while also delivering much better fuel economy. This is the case because an IC power plant according to the present invention produces much better torque and horsepower than does a conventional normally-aspirated IC engine. Conventional technology would require the engine to be supercharged (i.e., turbo-super charged or supercharged by a mechanically driven blower or pump) in order to provide comparable torque. Without the need for such supercharging, the present invention provides a relatively small engine with good fuel economy, but with increased torque and horsepower, providing a driving experience comparable to a vehicle powered by a considerably larger—and less fuel efficient—conventional IC engine.

The IC Engine and its Sources of Inefficiency

In order to understand the sources of inefficiency in modern automobiles, it is first necessary to consider the Otto cycle. The IC engines in most modern cars are based on the Otto cycle, a cycle of four strokes—intake, compression, combustion, and exhaust. The Otto cycle has good thermodynamic efficiency, results in IC engines with a high power-to-weight ratio and high reliability due to having relatively simple operation. Most improvements to the Otto cycle IC engines have had as a goal the increase of power, efficiency, and/or reduction in emissions. To improve the efficiency of the Otto cycle IC engine, it is necessary to understand where the inefficiencies arise. The Otto cycle engine is most efficient at about 40% to about 50% of it top speed, and at about 70% to about 80% of its peak torque. At higher engine speeds friction losses on fast-moving engine parts increases. Higher torques require the use of “fuel enrichment” which reduces the fuel efficiency. At lower torque, the engine suffers most from what is commonly termed “pumping losses” (further discussed below). At the efficiency “sweet spot” (as identified above) the IC engine produces around 40% of its full rated power output.

Ideally, then, manufacturers of modern automobiles would like to size the IC engines in their cars so that in the most common driving situations the engine can deliver about 40% of its rated power. Unfortunately, such an automobile would not be able to accelerate according to the expectations of the driving public. Further, such a car would not be able to climb hills very well at all. This is because the power requirements for a common car to cruise on level roads at highway speeds is only about 15 HP. At lower speeds, the driving power necessary from the engine is considerably less. But, if the car is given an IC engine of only 30 HP in order to operate the engine in its “sweet spot” (i.e., about 40% of peak power) under cruising conditions, then the car would require about 30 seconds to accelerate from a standstill to 60 MPH. This same car would slow to about 30 MPH on a long hill of about 10% slope. Steeper hills would be difficult indeed with such an under powered car. The driving public simply will not purchase such an underpowered car. As a result, contemporary cars, even small cars such as the Toyota Corolla, for example, have engines much too large for the engine to operate at or even near to its “sweet spot” under most driving conditions. For larger or higher performance automobiles, the departure from efficient operation conditions and design criteria is even more remarkable. As a further example, the current Toyota Corolla has an IC engine of 132 HP, and producing 128# ft of torque. As a result, almost all the time the power demands on this engine are far below the efficiency “sweet spot of the engine—and fuel efficiency for the car suffers as a result. Yet, currently the Toyota Corolla is generally considered a “fuel efficient” or economy car.

Pumping Losses

At low power outputs for the conventional IC engine, the major cause of low efficiency is pumping losses. The way an Otto cycle IC engine of 132 peak HP (continuing the example above of the Toyota Corolla) is persuaded to produce a far lower output, of say 10 to 15 HP, is that the flow of air into the cylinders is throttled by use of a throttle valve. This forces the engine to pull the intake air through a restricted opening, creating a partial vacuum in the intake manifold. As the air enters the cylinders during an intake stroke under such conditions, it is well below atmospheric pressure, and there is less air to fill the cylinders. A correspondingly smaller amount of fuel is injected (or provided by a carburetor) causing the engine to produce the lower power desired. However, maintaining the partial vacuum in the intake manifold wastes considerable energy, leading to greatly decrease engine efficiency. This is the case because as the pistons move away from the combustion chambers on their intake strokes, they are acted on by normal atmospheric pressure on one side (i.e., next to the crankshaft) and by a partial vacuum on the side next to the combustion chambers. This difference in pressures acting on the pistons takes power from the crankshaft, power which is not available to propel the car. Modern cars suffer from such pumping losses almost all the time, even at cruising speeds. Some have in the past attempted to reduce such pumping losses for an IC engine by applying a partial vacuum inside the crankcase of the engine. This expedient requires the use of a vacuum pump (or other source of vacuum), and carefully designed plumbing (the air drawn from the crankcase is full of oil vapors), as well as seals at all of the engine openings to ambient. Such seals at the crankshaft, at oil filler openings, and at emission control connections to the engines have proved simply too problematical for this expedient to have received wide application. Another expedient has been the development of engines that disable one or several cylinders when possible. These engines (i.e., so called 4-6-8 engines, for example) are V8's which disable two or four of the cylinders in order to reduce pumping losses. But, these engines are also mechanically complex and expensive.

In view of the above, objects for this invention are to achieve one or more of: allowing engine downsizing while maintaining acceptable drivability (thereby indirectly increasing fuel efficiency), increasing exhaust volumetric efficiency for an IC engine, decreasing requirements for fuel enrichment, reducing IC engine internal frictions by providing an IC engine operating at lower RPM, directly increasing fuel efficiency for an IC engine.

Further to the above, in the context of modern automobiles, the present invention provides an opportunity to reduce the use of precious metals necessary in catalytic converters. Catalytic converters generally use precious metals, such as platinum, palladium, iridium and rhodium in order to catalyzed unburned hydrocarbons, and other undesirable exhaust constituents before they are released from the vehicle tail pipe. The use of these precious metals can be reduced by employing the present invention because the echo chambers of the present invention, by creating an echo pulsatile flow directed back toward the combustion chambers of the IC engine, convert the downstream flow of exhaust gasses flowing to the catalytic converter from a sharply pulsating high pressure flow into a smoother more continuous exhaust flow. By smoothing the exhaust flow experienced at the catalytic converter, the converter brick size can be reduced (thus reducing the use of the identified precious metals) while allowing a lower peak pressure drop across the converter brick. A smaller catalytic converter also warms up faster upon vehicle start up from cold, meaning that the catalytic converter reaches its operating temperature sooner, and begins catalyzing unburned hydrocarbons earlier, thus reduced total exhaust emissions for the vehicle. The slower, smoother flow of exhaust gasses through the catalytic converter also means that peak exhaust flow velocity experienced within the converter brick is reduced. This leads to longer average residence time for the exhaust gasses within the converter brick, and improved effectiveness for the catalytic converter.

Accordingly, one particularly preferred embodiment of the present invention provides an improved internal combustion (IC) power plant including an internal combustion engine (ICE) having an exhaust port, and the ICE producing a pulsatile flow of exhaust gasses including pulsatile sound energy via the exhaust port, and an exhaust system including a length of exhaust conduit in gas flow communication with the exhaust port and conveying the flow of exhaust gasses to ambient, an improvement comprising the exhaust system including an echo chamber in exhaust gas flow communication with the exhaust system and exhaust port at a selected location and including a reflective enclosure on the one hand returning pulsatile sound energy to the IC engine via the exhaust port, and on the other hand the echo chamber defining a selected volume mitigating the pulsatile nature of the flow of exhaust gasses at a determined location downstream of the selected location, whereby the ICE provides an increased torque and horse power production, and the peak flow velocity of the pulsatile flow of exhaust gasses is reduced at the determined location.

Other objects, features, and advantages of the present invention will be apparent to those skilled in the art from a consideration of the following detailed description of a preferred exemplary embodiment thereof taken in conjunction with the associated figures which will first be described briefly.

### BRIEF DESCRIPTION OF THE DRAWING FIGURES

FIG. 1 provides a schematic and illustrative view of an automotive vehicle equipped with an internal combustion engine and exhaust system embodying the present invention;

FIG. 1A provides a diagrammatic view of one bank of the internal combustion engine seen in FIG. 1;

FIG. 2 is a schematic perspective view, partially in phantom lines, of the internal combustion engine and exhaust system according to this invention as seen in FIG. 1;

FIG. 3 provides a diagrammatic plan view of the automotive vehicle seen in FIGS. 1 and 2, and illustrates particularly a pair of echo chambers which form a part of the system combining the internal combustion engine and exhaust system;

FIG. 4 provides a diagrammatic plan view of an automotive vehicle similar to that seen in FIGS. 1-3, and illustrates particularly a pair of variable length echo chambers which form a part of the system combining the internal combustion engine and exhaust system;

FIG. 5 provides a diagrammatic plan view of an automotive vehicle similar to that seen in FIGS. 1-3, and similar to that of FIG. 4, and illustrates particularly a pair of variable geometry, valved, dual-length echo chambers which form a part of the system combining the internal combustion engine and exhaust system;

FIG. 5A illustrates a valving portion of one of the echo chambers seen in FIG. 5 in which a valve portion of the echo chamber is closed in order to provide a chamber of shorter length;

FIG. 6 illustrates a portion of an exhaust system of an IC power plant including a folded coaxial echo chamber which is valved to provide dual lengths;

FIGS. 7 and 7A illustrate a portion of another embodiment of an exhaust system of an IC power plant, in which an echo chamber includes features of a Helmholtz chamber and of a ¼ wave or ½ wave chamber, with an actuator for changing the echo chamber respectively from one configuration to the other as is illustrated in these two drawing Figures;

FIG. 8 illustrates a portion of yet another embodiment of an exhaust system of an IC power plant, in which an echo chamber also has features of a Helmholtz chamber and also has variable geometry effected by an actuator and movable wall portion to provide a continuously variable length for the echo chamber;

FIG. 9 is a graph of torque versus engine speed for several actual tests on a dynamometer of an IC power plant embodying this invention; and

FIG. 10 is a graph of a torque versus engine speed for another embodiment of the present invention actually tested on a dynamometer.

### DETAILED DESCRIPTION OF EXEMPLARY PREFERRED EMBODIMENTS OF THE INVENTION

While the present invention may be embodied in many different forms, disclosed herein are several specific exemplary embodiments which illustrate and explain the principles of the invention. In conjunction with the description of these embodiments, a method of providing and operating an internal combustion power plant according to this invention will be apparent. It should be emphasized that the present invention is not limited to the specific embodiments illustrated.

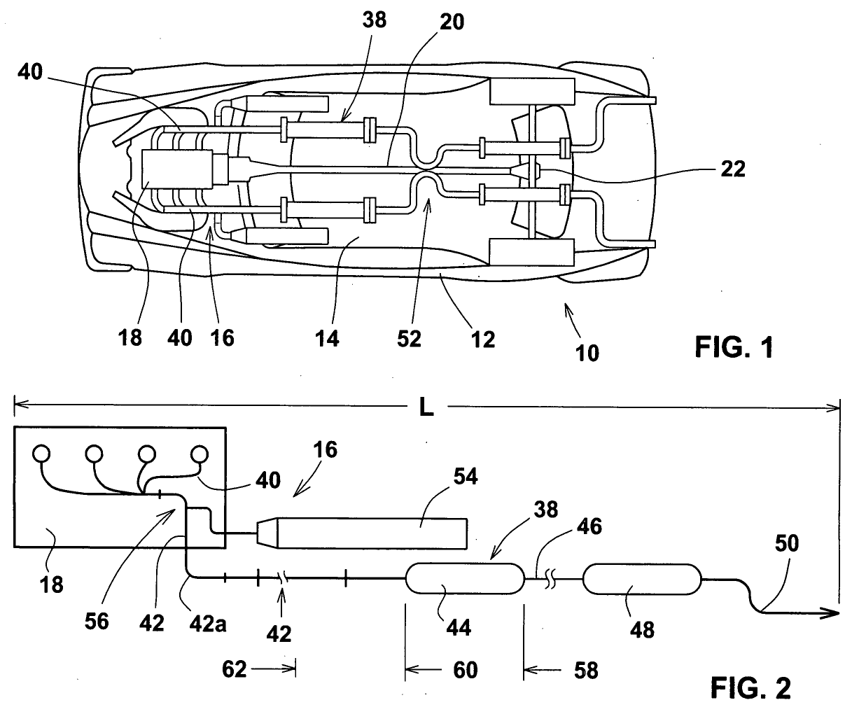

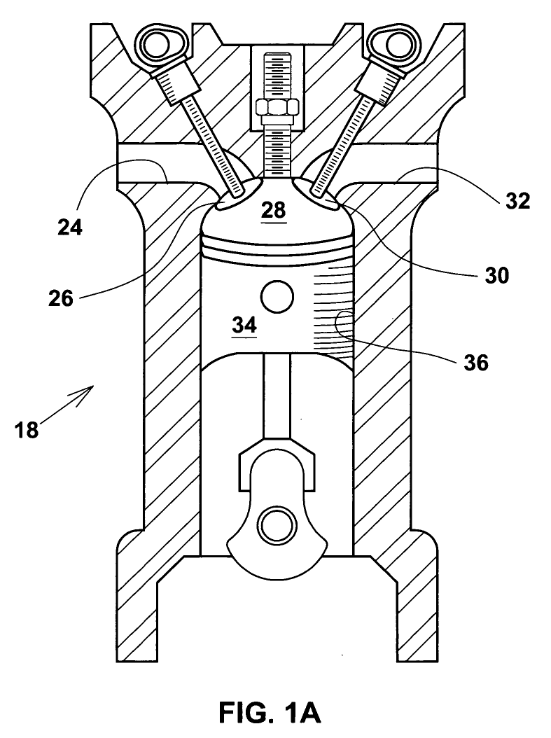

FIG. 1 diagrammatically illustrates an automotive vehicle 10 having a chassis and body, generally indicated with the numeral 12. The chassis and body 12 define therein a passenger compartment, which is generally indicated with the numeral 14. The vehicle 10 may is seen to be of front-engine design, and may be rear wheel drive, front wheel drive, or all wheel drive, although the invention is not so limited. That is, it is to be understood that an IC power plant according to this invention may be used, for example, to power an aircraft, or a boat, or to power a highway truck or an off road vehicle, such as a construction vehicle. Importantly, the automotive vehicle 10 includes a power plant, which is generally indicated with the numeral 16. This power plant according to this particularly preferred embodiment, includes an internal combustion (IC) engine 18, a transmission and drive shaft combination, indicated with the numeral 20, and a rear axle 22. Also, the IC engine 18 of the power plant 16 may be of Otto cycle type (i.e., spark ignition 4-stroke cycle) or Diesel cycle type (i.e., compression ignition 4-stroke cycle). The engine 18 may be of piston type, or of Wankle design, without limitation. Any engine configurations, such as in-line, V, opposed, and radial may be utilized with the present invention.

Viewing FIG. 1A, it will be seen (and is further explained below), that the IC engine 18 thus includes an intake port 24 leading to an intake valve 26, and communicating to a combustion chamber 28. The combustion chamber 28 similarly communicates with ambient via an exhaust valve 30 controlling flow of combustion products to an exhaust port 32. A piston 34 reciprocates in a bore 36 (i.e., cylinder) of the engine 18 and forming a part of (or communicating with) the combustion chamber 28, so that the combustion chamber has or communicates with a variable volume in response to reciprocation of the piston 34. As will be familiar to those ordinarily skilled in the pertinent arts, the piston 34 makes four (4) strokes along the length of the bore 36 in order to complete one cycle for the engine 18. The engine 18 may have plural valves (i.e., four or more valves for each cylinder) and may have plural cylinders, and also the engine may have fixed or variable valve timing. In the illustrated embodiment, the engine 18 may be of V-configuration, although only one bank of the V is illustrated, and the invention is not so limited.

Considering FIGS. 1 and 2 in conjunction with one another, it is seen that the power plant 16 includes an exhaust system, generally indicated with the numeral 38. This exhaust system includes a pair of exhaust manifolds 40 each mounted to the engine in communication with the exhaust ports of respective cylinders of the engine. Each exhaust manifold 40 communicates with a respective first section 42 of exhaust pipe extending downwardly and rearwardly along the vehicle 10. Thus, the pipe section 42 is commonly referred to as a down pipe. At the aft ends of each of the respective sections 42 of exhaust pipe are located one of a pair of first mufflers 44, each communicating with a respective second section of exhaust pipe 46. These second sections of exhaust pipe 46 in turn each communicates with a respective second muffler 48, and hence to a respective tail pipe 50. Conventionally, the pair of exhaust pipes 42 are interconnected by a cross-over 52, which in this case has an X-configuration. It will be understood that the details of the embodiment of power plant depicted and described by reference to FIGS. 1 and 2 are exemplary and that the invention is not limited to these precise details. That is, the power plant 16 could include a single exhaust system instead of the dual-exhaust illustrated in FIGS. 1 and 2.

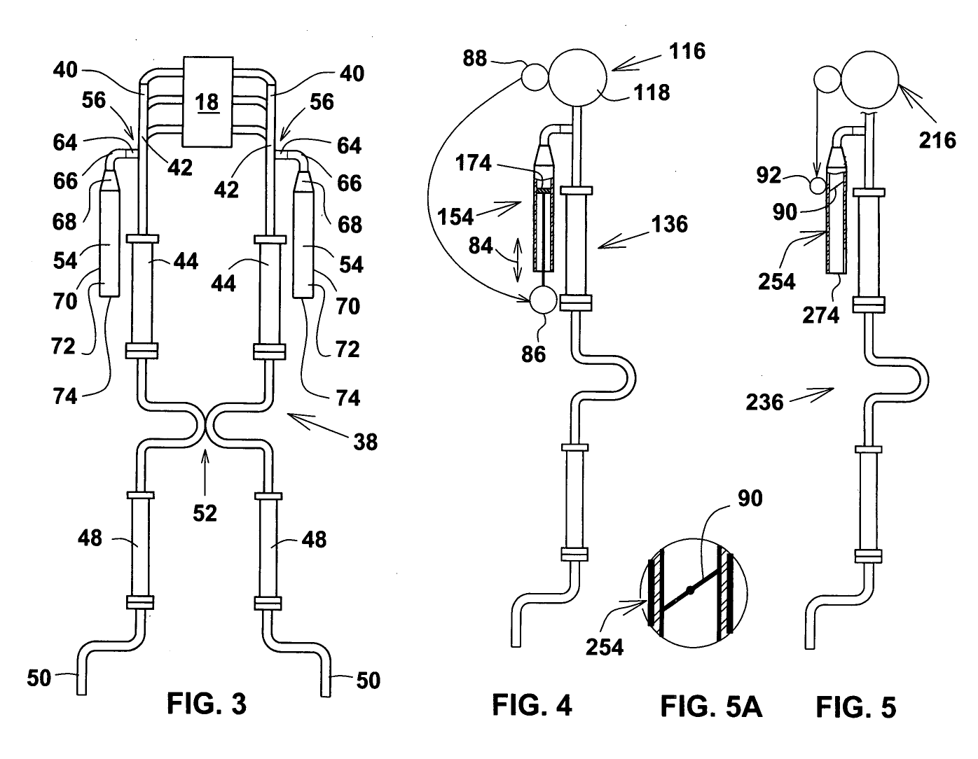

To this point in the disclosure of the exhaust system 38 of the power plant 16, all of the components are conventional and are well-known. However, returning to a consideration of FIGS. 1 and 2, and also considering FIG. 3, it is seen that the exhaust system 38 of power plant 16 includes a pair of echo chambers (or reactive sound reflecting chambers) 54, each connecting to a respective one of the exhaust pipes 42, or to the exhaust manifolds 40 preferably as close as is practicable to the exhaust valves of the engine 18. In this embodiment, the echo chambers 54 each connect in flow communication with the exhaust ports and combustion chambers of the engine 18 at a location indicated with the arrowed numeral 56.

Stated differently, it is seen in the illustration of FIG. 2 particularly that the exhaust system 38 has a length “L” extending from the exhaust valves and exhaust ports of the engine 18 rearwardly of the vehicle 10 along a flow path defined in combination by the exhaust manifolds 40, exhaust pipes 42 and 46, and mufflers 44 and 48, leading to the tail pipes 50. As is seen in FIG. 2, the first section of exhaust pipe 42 includes a serpentine down tube section 42a. This down tube section extends only a little way along the length of the vehicle 10 but adds length to the exhaust system 38 because of its downward extent. The cross-over 52 does not significantly change the length of this exhaust system 38, but merely serves to balance pressures and flows on the opposites sides of the illustrated dual exhaust system. That is, it is clear and well understood that a vehicle with a single exhaust system would not include a cross-over 52, and use of a cross-over is not essential to successful operation of the present invention.

However, in view of the above, it is to be noted that the connection point 56 is forward (i.e., closer to the exhaust valves and exhaust ports of engine 18) of a point 58, which point indicates the mid-length point of the exhaust system 38. More preferably, the point 56 is located forward of a point 60, which indicates the ⅓ length point of the exhaust system 38. And, most preferably, the point 56 is located forward of a point indicated with the numeral 62, which indicates the ¼ length point of the exhaust system 38. The point at which the point of connection 56 for the echo chambers 54 can be located will in many cases have to be selected in view of design criteria having to do with the overall design of the vehicle 10, with the size and location of its passenger compartment, its engine, and many other design criteria beyond the scope of this discussion. However, it is desired to have the echo chambers communicate with the remainder of the exhaust system as close as is practicable to the exhaust valves and exhaust ports of the engine 18.

Turning now to particular consideration of FIG. 3, it is seen that the echo chambers 54 each have a nipple 64 communicating with a respective one of the exhaust pipes 42 (i.e., in the form of a T-connection, although the invention is not so limited), and an elbow section 66 of pipe communicating between the nipple 64 and a divergent or cone shaped section 68. The cone shaped section communicates with a length of tubing 70 which defines the main echo chamber volume 72. In order to accomplish the most decisive and certain echo formation, the echo chamber volume 72 leads to a bluff reflective end wall 74 closing the distal end of the tubing 70. Most preferably, the pair of echo chambers 54 are substantially the same, and each one has a length measured along the exhaust system 38 from the exhaust valves of the engine to the bluff reflective end wall 74 which is determined such that a particular advantage (further discussed below) is achieved in the performance of the engine 18 of power plant 16.

Also, a particular range of volumes for the echo chamber volume 72 of each of the echo chambers 54 is expected to provide the best results for this invention, although testing has shown that a considerable range of volumes can be employed and still enjoy the benefits of this present invention. Particularly, it is believed that a volume for the echo chamber of from about 1/10 to 4 times the displacement volume of the engine will give an effective embodiment of the present invention. Also, while it is noted that the echo chambers 54 of FIG. 3 are essentially straight, and run parallel over their length with the exhaust pipes 42, the invention is not so limited. In other words, the necessities of packaging the echo chambers 54 beneath particular automobiles or in the space allotted in the automobile for the exhaust system may result in the echo chambers being formed in a variety of configurations other than straight. Some of the alternative shapes and configurations for the echo chambers are presented here, but they are exemplary only, and the invention is not so limited. For example, it may be desirable to make the echo chambers coaxial with the exhaust pipes over a length of those exhaust pipes in order to best fit the inventive exhaust system into the locations for an exhaust system provided with an existing or future automobile design.

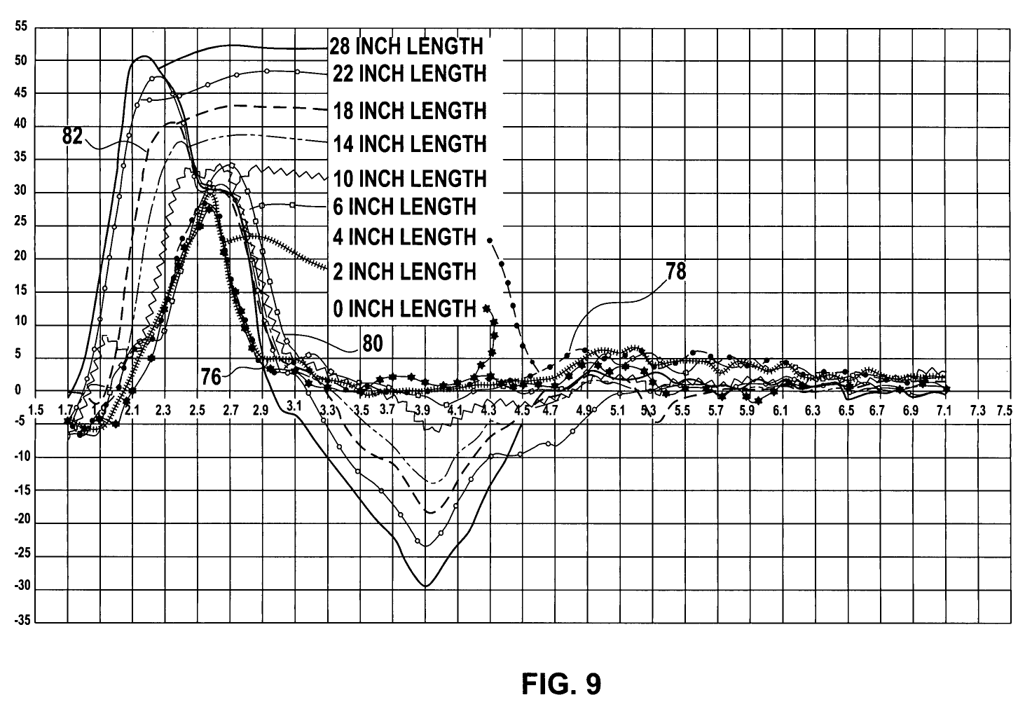

Considering now the graph of FIG. 9, the results of testing involving the installation of an exhaust system embodying the present invention onto an otherwise stock automobile having a 3.5 liter engine (i.e., with no other modifications) is shown. Installation of the inventive exhaust system converted the stock IC engine of the test automobile (in combination with the inventive exhaust system) into an IC power plant according to this invention. The inventive exhaust system was configured for purposes of this test so that the effective length and volume of the echo chambers could be manually varied between tests (i.e., by moving the bluff reflective end wall along the length of an elongate echo chamber) in order to provide differing test conditions for the power plant. In other words, these echo chambers were test articles, allowing the bluff end wall of the echo chambers to be manually moved between tests. In order to assure a high degree of accuracy and repeatability for testing of embodiments of the present invention, the Applicant acquired a DynaPack, model 4000 chassis dynamometer. This type of chassis dyno does not employ a drum driven by the tires of the vehicle under test (which drum type of drive allows for slippage), but instead utilizes a direct hub connection to the driven axles of the vehicle. A description of this dyno can be found at: dynapackusa.com/repeatability.htm. This graph of FIG. 9 is normalized along the horizontal axis to the stock torque output of the engine, so that the stock output appears along the horizontal zero (0) line of the graph. On the vertical scale of this graph, the torque values are shown as percentages of increase (or decrease) in comparison to the stock torque produced by the engine at a particular speed.

Considering first the line 76 of FIG. 9, it is seen that an echo chamber of 2 inches length produced a considerable torque increase extending over a speed range from about 2000 RPM to about 3100 RPM, which reached a peak at of about 15 percent increase at about 2600 RPM. A further more modest torque increase extended from about 4000 RPM all the way to the RPM limit of the engine at 7100 RPM. It is to be noted that the connection point for the echo chamber in this and the following tests was within three feet of the exhaust ports along the length of the exhaust system. Preferably, this connection point is at the exhaust ports, or within three feet of length along the exhaust system. However, a more distant connection point for the echo chamber may be utilized, as is described herein.

However, as is shown by line 78 of FIG. 9, an echo chamber of 4 inches length produced about the same low speed torque increase extending over a speed range from about 2000 RPM to about 3100 RPM, which also reached a peak at of about 15 percent increase at about 2600 RPM. This slightly longer echo chamber length provided a slightly greater torque increase than did the 2 inch chamber, extending from about 4000 RPM all the way to the RPM limit of the engine at 7100 RPM.

Similarly, the line 80 of FIG. 9, shows that an echo chamber of 6 inches length produced a torque increase extending over a speed range from about 1800 RPM to about 3700 RPM, which reached a peak at about 18 percent at about 2600 RPM. However, for the first time with this length of echo chamber, we seen a torque decrease at about 3900 RPM. This same 6 inch echo chamber length produced a substantial torque increase beginning at about 4700 RPM, and extending to the RPM limit of the engine.

However, the line 82 of FIG. 9 shows the testing results for an echo chamber of 18 inches length, which produced a torque increase extending over a speed range from about 1900 RPM to about 3300 RPM, which reached a peak at about 19 percent at about 2400 RPM. However, this 18 inch echo chamber also caused a substantial torque decrease of about 15 percent at about 3900 RPM, and another smaller torque dip at about 5300 RPM. Although there was a region of torque gain in between these two torque dips, the torque gain out to the RPM limit of the engine was not as substantial as other lengths of echo chambers. However, this testing on this particular engine showed that the echo chamber of 18 inch length was alone in producing the sharp torque dip at about 5300 RPM.

Additional echo chambers of 10, 14, 22, and 28 inches were configured using the test-article echo chambers (i.e., by manually moving the bluff reflective end wall of the test-article echo chambers) and tested on the same vehicle by the Applicant, with the results of these tests being shown also on FIG. 9. As can be seen in FIG. 9, the echo chambers of 22 and 28 inches length produced dramatic improvements in the low speed torque production of the engine, but also resulted in dramatic torque dips at about 3900 RPM. From this we can conclude that for IC power plants with engines operating at lower speeds, perhaps such as those used for water pumping, for electrical power generation, or for aircraft or boat propulsion, that an echo chamber installation according to this invention could result in a substantial torque advantage.

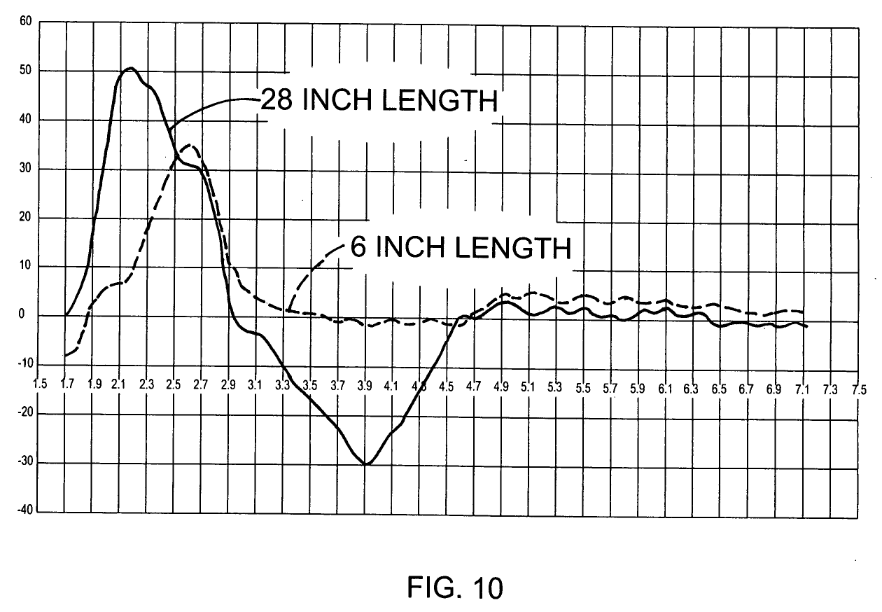

However, moving on now to a consideration of FIG. 10, it is seen that for the same 3.5 liter engine, an echo chamber of 28 inches length produces the expected low RPM torque increase. However, in this case, careful selection of the volume and shape of the echo chamber has resulted in a torque increase not of the 20 to 22 percent experienced in the earlier testing, but of substantially 50 percent over the same engine in stock condition. Similarly, an echo chamber of 6 inches length produced in this instance a torque increase of about 35 percent. As is seen on FIG. 10, the torque increase lines cross in the RPM range from about 2500 RPM to about 2700 RPM. While the longer echo chamber produced the expected torque dip at higher RPM, this effect can be avoided by switching the longer echo chamber out within the 2500 RPM to about 2700 RPM cross over range mentioned above, and inserting the shorter 6 inch echo chamber. However, physically removing one echo chamber and installing another on a running engine is not practicable. So, the Applicant has determined that a variable geometry or valved echo chamber (or echo chambers) offers substantially an optimum design for this particular test engine.

FIG. 4 illustrates an IC power plant 116 including an IC engine 118 and exhaust system 136 (both indicated schematically) embodying this present invention. It is seen in FIG. 4 that the echo chamber 154 has been constructed with a bluff reflective wall 174 which is sealingly movable along the length of the chamber 172, rather like a piston moving along a bore, as is indicated by arrows 84. An actuator 86 is provided to move the wall 174 linearly along chamber 172 in response to a speed sensor and control circuit or device, indicated with numeral 88. The sensor and controller circuit or device is responsive to the speed of the IC engine 118 to move the wall 174 to optimum positions in view of the test data indicated in FIG. 9. Thus, the IC power plant 116 provides a significant torque increase over substantially its entire speed range compared to a stock engine, and has no detrimental torque dips.

However, in view of the test results discussed above with reference to FIG. 10, it is seen that substantially all of the benefit of the present invention can be realized utilizing a considerably more simple, robust, and less expensive implementation of the present invention. Considering now FIG. 5, it is seen that familiar reference numerals have been increased by 100 and indicate familiar structures or features. In FIG. 5, the echo chamber 254 has been constructed with a bluff reflective wall 274 which is fixed in position, substantially at the 28 inch length seen indicated on FIG. 10. However, a valve 90, preferably of butterfly valve configuration, although the invention is not so limited, is disposed in the chamber 254 substantially at the location corresponding to a chamber length of about 6 inches. As FIG. 5A shows, for lower speed operation of the engine 118, the valve 90 is maintained in an open position, so that the bluff reflective wall 274 is effective to provide the torque increase indicated on FIG. 10 for speed below about 2500 RPM to about 2700 RPM.

A speed sensor and control circuit or device, indicated with numeral 188 is used to provide an output signal responsive to the speed of the IC engine 118 to dither the valve 90 between its opened and its closed positions in a bi-stable manner. In other words, at an engine speed of about 2500 RPM to about 2700 RPM with engine speed increasing, the valve 90 is dithered to a closed position. Conversely, at an engine speed of about 2500 RPM to about 2700 RPM with engine speed decreasing, the valve 90 is dithered to its opened position. A bi-stable actuator 92 is utilized to accomplish this dithering of the valve 90. With the valve 90 in its closed position, the butterfly valve plate of the valve serves as a bluff reflective wall, giving the echo chamber 254 an effective length of about 6 inches. Accordingly, it is seen that the effective length of the echo chamber 254 is changed between two values or lengths in response to the speed of the IC engine 118 and in view of the test data indicated in FIG. 10. Thus, the IC power plant 116 associated with the echo chamber 254 provides a significant torque increase over substantially its entire speed range compared to a stock engine, and has no detrimental torque dips.

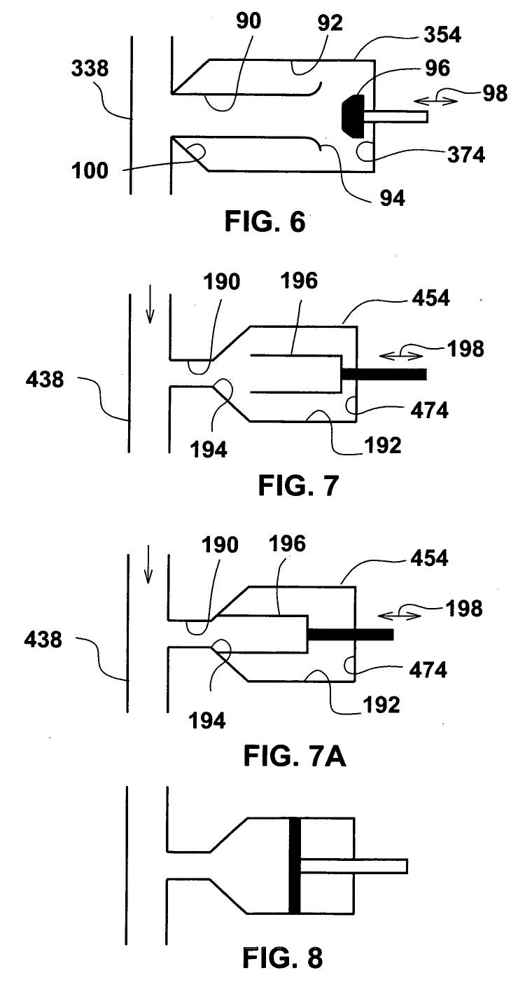

Turning now to FIG. 6, an alternative embodiment of the invention including an echo chamber is illustrated, with the echo chamber having characteristics of both a Helmholtz resonator and of a ¼ wave resonator. In FIG. 6 familiar reference numerals have been increased again by 100 and indicate familiar structures or features. In FIG. 6, the echo chamber 354 has been constructed with an inner connection passage 90 providing communication with the exhaust pipe 338. The inner connection passage extends within an outer generally concentric chamber 92, and has an open end 94. A plug valve member 96 is movable, as is indicated by arrow 98, between a first position spaced from the open end 94 and adjacent to a first bluff wall 374, and a second position in which the plug valve member 96 engages the adjacent end of the passage 90 and closes the open end 94. Consequently, when the plug valve member 96 is in its second position, the echo chamber 354 has a comparatively short length, and the face of the plug valve 96 serves as a bluff reflective surface. On the other hand, when the plug valve member 96 is moved to its second position, the bluff reflective wall 374 serves as a first of two confronting bluff reflective walls confronting one another across a distance. In this embodiment, the second bluff reflective wall is annular, and is defined by the annular end wall 100 of the chamber 354. Because sound pulsations must echo off wall 374, off wall 100 and back to wall 374 (i.e., for ¼ wave or ½ wave resonators) before being returned to the exhaust pipe again via connection passage 90, when the plug valve 96 is opened, the effective length of the echo chamber 354 becomes more than four times the length of the passage 90. It will be noted that for Helmholtz type resonators, these are dependent on enclosed volume, not on the presence of a reflective wall surface. In other words, the longer effective length of the echo chamber 354 is folded on itself in order to make the physical length of this structure much shorter. In this way, a short echo chamber length of, for example, 6 inches, and a longer echo chamber length of about 28 inches can be provided in a compact structure that is more easily packages in the confines of a passenger automobile. As before, a speed sensor and control circuit or device are preferably utilized along with an actuator, in order to shift the plug valve 96 between its two positions as a function of engine speed.

FIG. 7 illustrates another alternative embodiment of the invention including an echo chamber structure with two different effective lengths. This echo chamber structure may also be considered to have characteristics of both a Helmholtz resonator and of a ¼ wave resonator. In FIG. 7 familiar reference numerals have been increased again by 100 and indicate familiar structures or features. In FIG. 7, the echo chamber 454 has been constructed with a first connection passage 190 providing communication with the exhaust pipe 438. The connection passage extends to a larger generally concentric chamber 192, and has an opening at 194 to this larger chamber. A cup-shaped valve member 196 is movable, as is indicated by arrow 198, between a first position spaced from the opening 194 and adjacent to a bluff wall 474, and a second position in which the cup-shaped valve member 196 engages at its open end at the opening 194 of the connection passage 190 (as is seen in FIG. 7A). On the other hand, when the connection passage 190 is communicating at opening 194 with the larger chamber 192, then a bluff reflective surface 474 of this larger chamber 192 is effective to provide echoes of sound energy back to the engine communicating with the chamber 454. It is to be noted that the echo chamber 454 particularly has construction features characteristic of a Helmholtz type of resonator, so that the effective length of the chamber 454 is greater than its physical length. Again, in this way, a short echo chamber length (i.e., with valve member 196 engaging communication passage 190) of, for example, 6 inches, and a longer effective echo chamber length of about 28 inches can be provided in a compact structure.

FIG. 8 illustrates a portion of yet another embodiment of an exhaust system of an IC power plant, in which an echo chamber also has features of a Helmholtz chamber and also has variable geometry effected by an actuator and movable wall portion to provide a continuously variable length and volume for the echo chamber. The embodiment of FIG. 8 is essentially the same at that shown in FIG. 4, but is presented diagrammatically, and perhaps better illustrates how an echo chamber may have characteristics of both a ¼ wave chamber, and of a Helmholtz type of chamber. In addition to having this dual-nature, the echo chambers of FIGS. 4 and 8 have the moving wall type of variable geometry, discussed above by reference to FIG. 4.

Having observed the structure and function of an IC power plant according to this invention, including an IC engine, attention may now be directed to uses of this power plant to significantly improve the possible trade offs in performance, fuel economy, and reduced air pollution of automobiles, including a reduction in the use of precious metals, such as platinum utilized in catalytic converters. As a first consideration, it has been explained above that the torque and horse power of an IC power plant according to this invention is remarkably improved. Thus, an automobile using a smaller IC engine according to this invention can provide substantially the same driving experience, and so will be accepted by consumers. And, the smaller engine will use less fuel, produce less air pollution, and have a smaller carbon footprint. Further, because the present invention lowers the peak exhaust gas flow through a catalytic converter, and increases the effective residence time for exhaust gasses in that catalytic converter, a smaller converter using less precious and expensive metals can be utilized further lowering the cost of the vehicle. It follows from the smaller size of the converter that a smaller catalytic converter will heat up more quickly from cold to its necessary catalyzing temperature, thus meaning that the automobile will emit less unburned hydrocarbons into the atmosphere, and will pollute less each time it is started from cold. Further, it is believed that this invention has applicability to turbocharged engines as well, with the echo chamber(s) connecting between the exhaust ports of the engine and the turbocharger. Thus, a turbocharged engine may enjoy an increase in cylinder scavenging, a reduction in peak exhaust flow back pressure because of the accumulator effect of the echo chamber(s) communicating with the exhaust ports, as well as possibly an improvement in turbocharger efficiency because of the turbocharger receiving a more uniform exhaust gas flow (i.e., similarly to the smoothing of exhaust gas flow that occurs at a catalytic converter.

Those skilled in the pertinent arts will further appreciate that the present invention may be embodied in other specific forms without departing from the spirit or central attributes thereof. For example, it is apparent that the reflective wall (i.e., wall 74, for example) need not be bluff, but may be merely effective as a reflective surface. In fact, the echo chamber may simply be formed as a reflective enclosure effective to reflect pulsatile energy back to the IC engine. Further, a variation of an effective echo chamber may comprise the inclusion of absorptive material within the echo chamber, which it is believed will have the effect of lowering the resonant frequency of the echo chamber. Further, the echo chamber(s) according to this invention need not be dead-ended as are the preferred embodiments presented in this disclosure. That is, an effective echo chamber may also be configured as a flow-through structure, having an exhaust inlet and an exhaust outlet. Because the foregoing description of the present invention discloses only particularly preferred exemplary embodiments of the invention, it is to be understood that other variations are recognized as being within the scope of the present invention. Accordingly, the present invention is not limited to the particular embodiment which has been described in detail herein. Rather, reference should be made to the appended claims to define the scope and content of the present invention.

I claim:

1. An improved internal combustion (IC) power plant including an internal combustion engine (ICE) having an exhaust port, and said ICE producing a pulsatile flow of exhaust gasses including pulsatile sound energy via said exhaust port, and an exhaust system including a length of exhaust conduit in gas flow communication with said exhaust port and conveying said flow of exhaust gasses to ambient, an improvement comprising said exhaust system including an echo chamber in exhaust gas flow communication with said exhaust system and exhaust port at a selected location and including a reflective enclosure on the one hand returning pulsatile sound energy to said IC engine via said exhaust port, and on the other hand said echo chamber defining a selected volume mitigating the pulsatile nature of said flow of exhaust gasses at a determined location downstream of said selected location, whereby said ICE provides ail increased torque and horse power production, and the peak flow velocity of said pulsatile flow of exhaust gasses is reduced at said determined location.

2. The IC power plant of claim 1 wherein said echo chamber has a single gas flow communication with said selected volume, and said single gas flow communication opens to said exhaust system at said selected location.

3. The IC power plant of claim 1 wherein said ICE is of 4-stroke cycle type.

4. The IC power plant of claim 1 wherein said exhaust system defines a length dimension measured along said length of exhaust conduit substantially from said exhaust port to a discharge opening at which said flow of exhaust gasses is discharged to ambient, and said selected location is closer to said ICE than one-half of said length dimension.

5. The IC power plant of claim 1 wherein said exhaust system defines a length dimension measured along said length of exhaust conduit substantially from said exhaust port to a discharge opening at which said flow of exhaust gasses is discharged to ambient, and said selected location is closer to said ICE than one-third of said length dimension.

6. The IC power plant of claim 1 wherein said exhaust system defines a length dimension measured along said length of exhaust conduit substantially from said exhaust port to a discharge opening at which said flow of exhaust gasses is discharged to ambient, and said selected location is closer to said ICE than one-fourth of said length dimension.

7. The IC power plant of claim 1 wherein said selected location is defined by an exhaust manifold of said ICE, said exhaust manifold being in direct flow communication with said exhaust port and flowing exhaust gasses to said exhaust conduit.

8. The IC power plant of claim 1 wherein said echo chamber defines a respective length dimension from said selected location to a distal reflective wall closing said echo chamber, and said distal reflective wall is disposed at a selected distance along said exhaust system and echo chamber from said exhaust port.

9. The IC power plant of claim 1 wherein said echo chamber defines a respective length dimension from said selected location to a distal reflective wall closing said echo chamber, and further including means for moving said distal reflective wall toward and away from said exhaust port along the length of said exhaust system and echo chamber.

10. The IC power plant of claim 9, wherein said means for moving said distal reflective wall is effective to move said distal reflective wall during operation of said ICE.

11. The IC power plant of claim 1 further including an additional reflective wall member disposed along the length of said exhaust system and echo chamber, and means for moving said additional reflective wall between a first position in which said echo chamber defines said selected volume and said distal reflective wall is effective to reflect sound energy from said selected distance, and a second position for said additional reflective wall in which said additional reflective wall reflects sound energy and said echo chamber defines a decreased effective volume which is less than said selected volume.

12. The IC power plant of claim 11 further including detecting means for detecting the operational speed of said ICE, and means responsive to said detecting means for moving said additional reflective wall member between said first and said second positions as a function of engine speed above or below a determined engine speed.

13. A method of improving the torque production of an internal combustion (IC) power plant including an internal combustion engine (ICE) having an exhaust port; said method consisting of the steps of:
providing for said ICE to produce a pulsatile flow of exhaust gasses including pulsatile sound energy via said exhaust port;
providing an exhaust system including a length of exhaust conduit in gas flow communication with said exhaust port and conveying said flow of exhaust gasses to ambient
communicating an echo chamber in exhaust gas flow communication with said exhaust system and exhaust port at a selected location
providing said echo chamber with a reflective enclosure;
utilizing said reflective enclosure to on the one hand return pulsatile sound energy to said IC engine via said exhaust port, and on the other utilizing said echo chamber to define a selected volume; and
employing said selected volume to mitigate the pulsatile nature of said flow of exhaust gasses at a determined location downstream of said selected location;
whereby said ICE provides an increased torque and horse power production, and the peak flow velocity of said pulsatile flow of exhaust gasses is reduced at said determined location.

14. The method of claim 13 further including disposing a catalytic converter in said exhaust system substantially at said determined location.

15. The method of claim 13 further including the steps of providing for said exhaust system to define a length dimension measured along said length of exhaust conduit substantially from said exhaust port to a discharge opening at which said flow of exhaust gasses is discharged to ambient, and disposing said selected location closer to said ICE than one-half of said length dimension.

16. The method of claim 13 further including the steps of providing for said exhaust system to define a length dimension measured along said length of exhaust conduit substantially from said exhaust port to a discharge opening at which said flow of exhaust gasses is discharged to ambient, and disposing said selected location closer to said ICE than one-third of said length dimension.

17. The method of claim 13 further including the steps of providing for said exhaust system to define a length dimension measured along said length of exhaust conduit substantially from said exhaust port to a discharge opening at which said flow of exhaust gasses is discharged to ambient, and disposing said selected location closer to said ICE than one-fourth of said length dimension.

18. The method of claim 13 further including the step of providing for said selected location to be defined at an exhaust manifold of said ICE.

19. The method of claim 13 further including the steps of providing for said echo chamber to define a respective length dimension from said selected location to a distal reflective wall closing said echo chamber, and disposing said distal reflective wall at a selected distance along said exhaust system and echo chamber from said exhaust port.

20. The method of claim 13 further including the steps of utilizing said echo chamber to define a respective length dimension from said selected location to a distal reflective wall closing said echo chamber, and further including means for moving said distal reflective wall toward and away from said exhaust port along the length of said exhaust system and echo chamber.

21. The method of claim 13 further including steps of providing an additional reflective wall member disposed along the length of said exhaust system and echo chamber, and providing means for moving said additional reflective wall between a first position in which said echo chamber defines said selected volume reflective enclosure is effective to reflect sound energy to said ICE, and providing for movement of said additional reflective wall to a second position in which said additional reflective wall reflects sound energy to said ICE from a distance which is effectively closer to said ICE than said reflective enclosure and said echo chamber also defines a decreased effective volume which is less than said selected volume.

22. The method of claim 21 further including the steps of providing detecting means for detecting the operational speed of said ICE, and means responsive to said detecting means for moving said additional reflective wall member between said first and said second positions as a function of engine speed above or below a determined engine speed.

23. An automotive vehicle comprising:
a chassis for carrying an internal combustion (IC) power plant including a 4-stroke internal combustion engine (ICE), said ICE including an exhaust port from which issues a noisy pulsatile flow of exhaust gasses;
an exhaust system in gas flow communication with said exhaust port, and said exhaust system including an elongate exhaust pipe conduit extending to an outlet opening at which said flow of exhaust gasses vents to ambient;
said exhaust system including an echo chamber in exhaust gas flow communication with said exhaust port and said exhaust pipe, said echo chamber including a distal reflective wall reflecting sound energy back to said ICE via said exhaust port.

24. The automotive vehicle of claim 23 wherein said exhaust system defines a length dimension measured along said elongate exhaust pipe conduit substantially from said exhaust port to said outlet opening, and said selected location is closer to said ICE than one-half of said length dimension.

25. The automotive vehicle of claim 23 wherein said exhaust system defines a length dimension measured along said elongate exhaust pipe conduit substantially from said exhaust port to said outlet opening, and said selected location is closer to said ICE than one-third of said length dimension.

26. The automotive vehicle of claim 23 wherein said exhaust system defines a length dimension measured along said elongate exhaust pipe conduit substantially from said exhaust port to said outlet opening, and said selected location is closer to said ICE than one-fourth of said length dimension.

27. The automotive vehicle of claim 23 wherein said echo chamber communicates with said elongate exhaust pipe conduit at a selected location, and said echo chamber further defines a respective length dimension from said selected location to said distal reflective wall, and said distal reflective wall is disposed at a selected distance along said exhaust system and echo chamber from said exhaust port.

28. The automotive vehicle of claim 23 wherein said echo chamber defines a determined volume.

29. The automotive vehicle of claim 23 wherein said echo chamber defines a respective length dimension from said selected location to said distal reflective wall, and further including means for moving said distal reflective wall toward and away from said exhaust port along the length of said exhaust system and echo chamber.

30. The automotive vehicle of claim 23 further including an additional reflective wall member disposed intermediate of said distal reflective wall and said exhaust port along the length of said exhaust system and echo chamber, and means for moving said additional reflective wall between a first position in which said echo chamber defines a determined selected volume and said distal reflective wall is effective to reflect sound energy from said selected distance, and a second position for said additional reflective wall in which said additional reflective wall reflects sound energy and said echo chamber defines a decreased effective volume which is less than said determined volume.

31. An exhaust system for an internal combustion (IC) power plant including a 4-stroke internal combustion engine (ICE), said exhaust system comprising:
an elongate exhaust pipe conduit for connection in exhaust flow communication with an exhaust port and combustion chamber of said ICE;
said elongate exhaust pipe extending to an outlet opening at which a flow of exhaust gasses from said ICE vents to ambient;
said exhaust system including an echo chamber for exhaust gas flow communication with said exhaust port of said ICE, and for exhaust gas flow communication with a combustion chamber of said ICE, said echo chamber defining a selected dead-ended volume, and said dead-ended volume forming a reflective enclosure reflecting sound energy back to said ICE via said exhaust port.
